(19) United States
(12) Patent Application Publication
(10) Pub. No.: US 2013/0315698 A1
(43) Pub. Date: Nov. 28, 2013

(54) Lifting and Mounting Apparatus and Method for a Salt/Sand Spreader

(71) Applicant: Jay DiSandro, Smithfield (RI)

(72) Inventor: Jay DiSandro, Smithfield (RI)

(21) Appl. No.: 13/875,095

(22) Filed: May 1, 2013

Related U.S. Application Data
(60) Provisional application No. 61/640,738, filed on May 1, 2012.

(51) Int. Cl. B65G 67/02

(52) U.S. Cl. CPC B65G 67/02
USPC 414/572; 414/809

(57) ABSTRACT

In general, the present invention has to do with storage and mounting assembly for removably mounting a hopper spreader to a vehicle. The invention includes a lifting and mounting apparatus for a salt/sand spreader having a plurality of pulleys and at least one winch connectable to the pulleys via corresponding set of cables. The invention also includes an adjustable structure for mounting the pulleys and the winch.

### CROSS-REFERENCE TO RELATED APPLICATIONS

The present application is related to, claims the earliest available effective filing date(s) from (e.g., claims earliest available priority dates for other than provisional patent applications; claims benefits under 35 USC §119(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith:

1. U.S. provisional patent application 61/640,738, entitled “Lifting and Mounting Apparatus for a Salt/Sand Spreader”, naming Jay DiSandro as inventor, filed 1 May 2012.

### BACKGROUND

1. Field of Use

These teachings relate generally to hopper spreaders for spreading dry and semi-dry, free flow materials, and more particularly, to a storage and mounting assembly for removably mounting a hopper spreader to a vehicle.

2. Description of Prior Art

The spreading of salt and/or sand is a requirement in many areas for maintaining roads, parking lots, and driveways during the winter months. Various types of hopper spreader units have been developed for spreading dry, free flow materials, such as salt and sand. Most non-commercial salt/sand hopper spreader units have been designed for mounting on vehicles such as pick-up trucks.

Because hopper spreader units are not used year round, the salt spreader units are often removably mounted on the pick-up truck. For one example, the hopper spreader unit is mounted on the rear of the pick-up truck using a frame that slides over or is otherwise secured to the tailgate back of vehicle and is supported on the bumper of the vehicle. One problem associated with mounting a hopper spreader unit on the rear of a pick-up truck is accessing of the vehicle's cargo bed via the tailgate. Various attempts have been made to improve mounting of such hopper spreader units, including, the development of swing-out mounting assemblies. Problems with swing-out hopper spreader units include damage to the hopper spreader unit and/or the vehicle when a loaded hopper spreader unit is pivoted. Other considerations include the time that is required to install a hopper spreader unit on a vehicle and the damage done to the vehicle when the hopper spreader unit is installed or removed. For example, the vehicle bumper may be scratched or damaged if the frame of the hopper spreader is mounted on or otherwise connected to the bumper. It will also be appreciated that the hopper spreader units are very heavy and require several people to lift into or out of the truck.

In another known arrangement, a hopper spreader unit is mounted to the vehicle using the existing trailer hitch on the vehicle. In this arrangement, a trailer hitch adapter attached to the frame of the hopper spreader unit includes a tube dimensioned to be received in an opening of the vehicle trailer hitch. The tube of the hitch adapter and the opening of the trailer hitch are rectangular in shape to resist rotation of the hopper spreader unit relative to the vehicle. However, due to the size and shape of the hopper of the hopper spreader unit, there is a tendency for the hopper spreader to rotate or wobble about an axis defined by the axis of the trailer hitch, allowing the hopper to pivot about the trailer hitch.

In yet another arrangement, the hopper spreader is mounted in the payload area of the flatbed pick truck. It will be appreciated that the hopper spreader is not lightweight, even when empty. It will also be appreciated that once the hopper spreader is mounted in the pickup truck payload area it is not easily and quickly removable, especially since it will likely contain some amount of sand or salt. Consequently, once the hopper spreader is mounted in the payload area it remains there for the season. Thus, the pickup truck generally loses its cargo carrying versatility for the remainder of the season.

In addition, if the hopper spreader is not empty it is difficult to judge the weight of the hopper, particularly if the contents are wet. Thus, severe injury can occur to the hopper and personnel if the hopper is attempted to be removed from the truck bed without knowing the approximate weight of the hopper.

It is accordingly an objective of the present invention provide an improved mounting assembly for removably mounting a hopper spreader to a vehicle.

The mounting/demounting assembly of the present invention must also be of construction which is capable of safely lilting most types of spreaders ranging from ¼ ton to 5 ton rated spreaders in and out of the payload area of the truck, weather resistant, and long lasting; and, it should also require little or no maintenance throughout its operating lifetime. In order to enhance the market appeal of the mounting assembly of the present invention, it should also be of inexpensive construction to thereby afford it the broadest possible market. Finally, it is also an objective that all of the aforesaid advantages and objectives be achieved without incurring; any substantial relative disadvantage.

With these and other objects in view, as will be apparent to those skilled in the art, the invention resides in the combination of parts set forth in the specification and covered in the claims appended hereto.

### BRIEF SUMMARY

The foregoing and other problems are overcome, and other advantages are realized, in accordance with the presently preferred embodiments of these teachings.

The disadvantages and limitations of the background art discussed above are overcome by the present invention which provides a mounting assembly for removably mounting to a vehicle's payload area a hopper spreader of the twe used for dispensing dry, free flow material.

The invention is also directed towards a lifting and mounting apparatus for removably installing salt/sand spreader onto a pickup truck's buck bed payload area, the apparatus includes a plurality of pulleys and at least one winch assembly connectable to the plurality of pulleys via a corresponding plurality of cables. The pulleys and winch are connectable to an adjustable structure adapted to lift and removably mount the salt/sand spreader. In one embodiment the adjustable structure includes four ten foot steel I-beam vertical supports having stabilizing foots, two ten foot outer cross steel I-beams connectable to the vertical supports, two 8 foot upper side steel I-beams connectable to the vertical supports, and two adjustable ten foot inner cross steel I-beams connectible to the two upper side beams. The invention also includes and overweight alert apparatus for alerting if the salt/sand spreader exceeds at least one predetermined weight, such as, for example, a gross vehicle rating of the pickup truck.

In accordance with one embodiment of the present invention a method for removably lifting and mounting a salt/sand spreader hopper (hopper) on a pickup truck's truck-bed payload area is provided. The method includes providing as hopper lifting and mounting apparatus, having a structure frame of sufficient depth, width, and height to accommodate the pickup truck. The method also includes providing, a hoisting system for attaching to the hopper, wherein the hoisting system comprises at least one winch; at least one hook; a plurality of pulleys and cables attachable to the at least one winch for transferring lifting power from the at least one winch to the at least one hook by redirecting the at least one cable. The method includes positioning the hopper within the lifting and mounting apparatus; attaching at least one strap to the at least one hook and the hopper and using the at least one winch to hoist the hopper a sufficient distance to clear the truck bed payload area. The method also includes providing determining means for determining if the hoisted hopper exceeds a predetermined weight sufficient to damage the hopper or if the hoisted hopper exceeds a predetermined weight sufficient to exceeds a gross vehicle rating of the pickup truck.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a front perspective view of a lifting and mounting apparatus for a salt/sand spreader in accordance with the present invention;

FIG. 2 is a right side perspective view of the invention shown in FIG. 1;

FIG. 3 is a top perspective view of the invention shown in FIG. 1;

FIG. 4 is a detailed perspective view of the winch-pulley system in accordance with the invention shown in FIG. 1;

FIG. 5 is a perspective illustration of an alternate embodiment of the present invention; and

FIG. 6 is a flow chart for one method of employing the invention shown in FIG. or FIG. 5 to removably mount a hopper spreader on a vehicle.

### DETAILED DESCRIPTION

The file following brief definition of terms shall apply throughout the application:

The term “outer” or “outside” refers to a direction away from a user, while the term “inner” or “inside” refers to a direction towards a user;

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example; and

If the specification states a component or feature “may,” “can,” “could,” “should,” “preferably,” “possibly,” “typically,” “optionally,” “for example,” or “might” (or other such language) be included or have a characteristic, that particular component or feature is not required to be included or to have the characteristic.

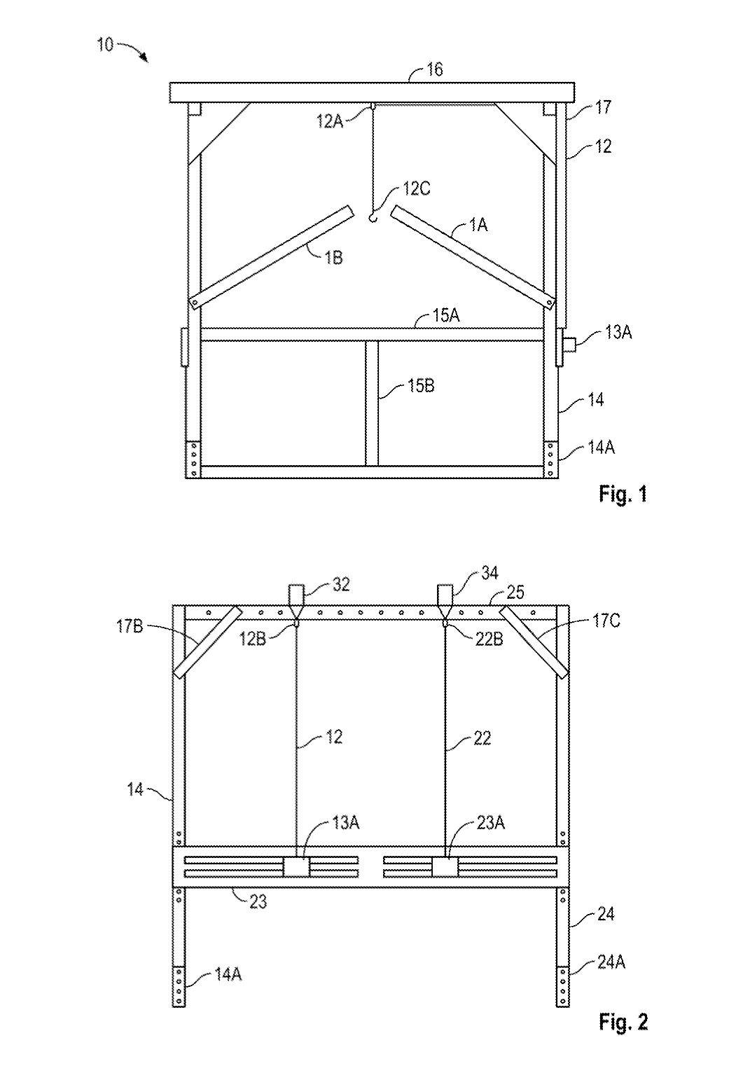

Referring to FIG. 1 there is shown a front perspective view of a lifting and mounting apparatus 10 for a salt/sand spreader in accordance with the present invention. As shown the lifting and mounting apparatus 10 includes vertical support beams 14 in adjustable sleeves 14A. It will be appreciated that vertical support beams 14 may be coupled to adjustable leveling sleeves 14A by any suitable coupling means such as a coupling pin. It will also be appreciated that vertical support beams 14 may be supported by a pin or bolt through adjustable sleeve 14A.

Still referring to FIG. 1 there is shown a winch 13A, cable 12, pulley 12A and hook 12C. Not shown in FIG. 1 is pulley 1213 which redirects the cable 12 from the winch 12A to pulley 12A. Pulley 12A redirects the cable 12, and hence the tensional force, to hook 12C. The winch/pulley/hook system will be described in more detail herein.

FIG. 1 also shows rear supports including, upper horizontal beam 15A, lower horizontal beam 15C, and vertical rear support beam 158. It will be appreciated that the rear supports may be any suitable material such as, for example, 4×4 wood beams.

Still referring to FIG. 1 there is shown left support beam 113 and right support beam 1A. Left support beam 1B and right support beam 1A are rotatable fixed at one end to vertical support beams 14, respectively. At the other end the left support beam 1B is mateable with the other end of the right support beam 1A. When mated in the closed position the left support beam 1A, mated with the right support beam 1A, provides front horizontal support as well as an added security feature.

Also shown in FIG. 1 is gusset 17 for horizontal stability. Gusset 17 may be any suitable material such as, for example, plywood, metal, or plastic. It will be understood that stabilizing bars may be used in place of gussets (see FIGS. 2, 17B and 17C).

Referring also to FIG. 2 there is shown a right side perspective view of the invention shown in FIG. 1. From this perspective winch 13A, cable 12, pulley 12B and pulley 128 support 34. Also shown are winch 23A, cable 22, and pulley 22B and pulley 228 support 32.

Still referring to FIG. 2, there is shown horizontal winch support beam 23. Horizontal winch support beam may be any suitable material and is adapted to allow winch 13A and winch 23A horizontal adjustment. Similarly, pulleys associated with winch 13A and winch 23A are also adjustable to planar conform the respective cables, 12, 22 and pulleys.

FIG. 2 also shows stabilizing bars 17B and 17C. Et will be appreciated that stabilizing bars 17B and 17C may be any suitable size, shape (such as gussets), or material required to stabilize and hold at right angles top horizontal support beam 25 with vertical support beams 14 and 24, respectively.

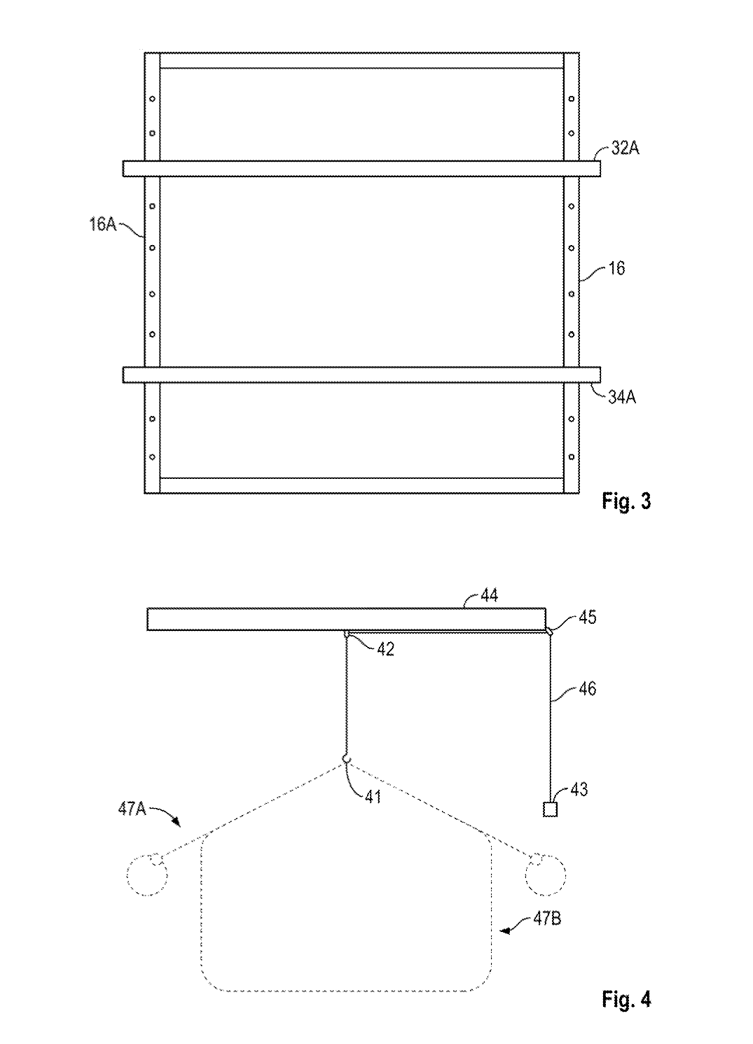

Referring also to FIG. 3 there is shown a top perspective view of the invention shown in FIG. 1. Forward pulley support beam 34A supports center pulley 12A and side pulley 12B. The aft pulley support beam 32A supports the aft center pulley (not shown for clarity) and side pulley 22B. Forward and at pulley support beams, 34A and 32A, respectively, may be any suitable load bearing structure. In addition, forward and aft pulley support beams 32A, 34A may be removably affixed to top support frame beams 16, 16A to provide extra structural support. It will be appreciated that forward and aft pulley support beams, 34A and 32A, respectively are adjustable along top support frame beams 16, 16A to planar conform the respective cables, 12, 22 and pulleys. Thus, making it possible to clasp, raise, lower, and/or hold most sized spreaders.

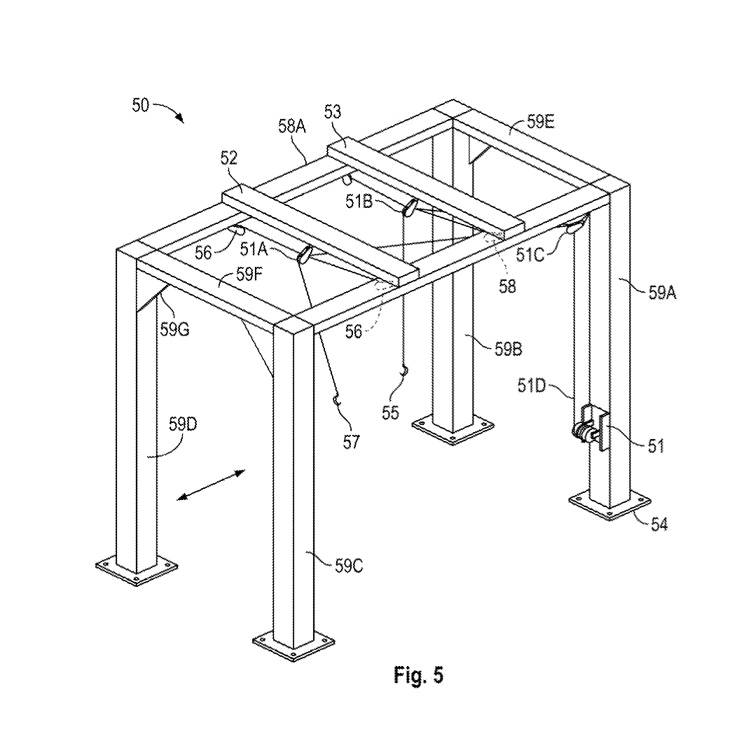

Referring also to FIG. 4 there is shown a detailed perspective view of the winch-pulley system in accordance with the invention shown in FIG. 1. As described herein the winch pulley system includes a winch 43, a cable 46, a pulley 45 for horizontal translation of the vertical direction of the cable 46, a pulley 42 for vertical translation of the horizontal direction of the cable 46, and a hook 41 connected to the cable 46. Also shown is load bearing beam 44(32A or 34A in FIG. 3). It will be understood that any suitable number of winch pulley systems may be used. It will also be appreciated that the cable-pulley system can be any suitable cable-pulley system suitable for indoor or outdoor use and storage; such as for example, rust proof cable-pulleys. Similarly, winch 43 may be any suitable type winch such as a hand operated winch or a powered winch.

Also shown are two options of harnessing and lifting/lowering the spreader using straps 47A and 47B. Strap 47A may grasp the spreader from lift points suggested by the manufacturer. Strap 47B shows the strap completely encircling, the spreader. Note that these strap systems grasp the spreader from two points using load bearing beams (see FIGS. 3-32A and 34A). Straps 47A and 47B may be any suitable material capable of holding/lifting the amount of weight required.

Referring to FIG. 5 there is Shown a perspective view of a lifting and mounting apparatus 50 for a salt/sand spreader apparatus for removably installing a spreader hopper in accordance with the present invention. As shown the lifting and mounting apparatus 50 includes vertical supports 59A-59D. Vertical supports may be any suitable material such as steel H-beams, also referred to as I-beams. The vertical supports 59A-59D is of a sufficient height to facilitate loading and removing a sanding hopper from a truck bed, typically about ten feet. The vertical supports also include stabilizer footing 54 for securing and stabilizing the lifting and mounting apparatus 50 to a solid foundation. It will be appreciated that the stabilizer footing 54 may be any suitable stabilizer footing adaptable to securing the lifting and mounting apparatus 50 to various foundation types, e.g., concrete slabs or dirt floors.

Lifting and mounting apparatus 50 also includes upper outer cross beams 59F, 59E, affixed to vertical support beams 59C, 591) and 59A, 59B, respectively. Outer cross beams may be any suitable material such as steel I-beams. Outer cross beams may be of sufficient width to facilitate loading and removing a sanding hopper from a truck bed, typically about ten feet.

Lifting and mounting apparatus 50 also includes upper side beams 58, 58A affixed between vertical support pairs 59A, 59C and 59B, 59D, respectively. Upper side beams may be any suitable material such as steel I-beams. Upper side beams may be of sufficient length to facilitate loading and removing a sanding hopper from a truck bed, typically about eight feet. Vertical support pairs 59A, 59C and 59B,59D may be gusseted with gussets 59G. It will be understood that any suitable number of gussets may be used to between 59A, 59C and 59B,59D and it's corresponding gusseted steel I-beam.

Still referring to FIG. 5, lifting and mounting apparatus 50 also includes inner cross beams 52, 53. Inner cross beams 52,53 may removably attached to upper side beams 52, 53 via thru mounting holes 56. Inner cross beams may be any suitable material such as steel I-beams. Inner cross beams may be of sufficient width to facilitate loading and removing a sanding hopper from a truck bed, typically about ten feet.

Also shown in FIG. 5 is pulley system 51A, 51B, 51C for transferring lifting power from winch 51 to sanding hopper (not shown in FIG. 5 for clarity) via lift hooks 55, 57 and cable assembly 51D. There may be any suitable number of pulleys, such as for example nine pulley blocks, for transferring lifting power from winch 51. In addition pulleys attached to inner cross beams, e.g., pulley 51A and pulley 51B may be permanently affixed to its respective cross beam or adjustably affixed to its respective cross beam.

Still referring to FIG. 5, winch 51 may be any suitable winch such as a manual winch or an electric (AC or DC) winch. In addition, winch assembly 51 may include an overweight alert, such as, for example, a scale for alerting (visual and/or audio alert) if the sanding hopper (not shown) exceeds a predetermined weight. For example, if the hoisted hopper exceeds a recommended rating, of the hopper due to the hopper not being empty or due to the contents of the hopper having excessive moisture. Another example may be if the hoisted hopper weight may contribute to exceeding the pickup truck's gross vehicle weight rating a weight alert is actuated. It will be appreciated that any suitable means for alerting a user that that the hopper weight may be used, including an emergency hoisting stop by the winch.

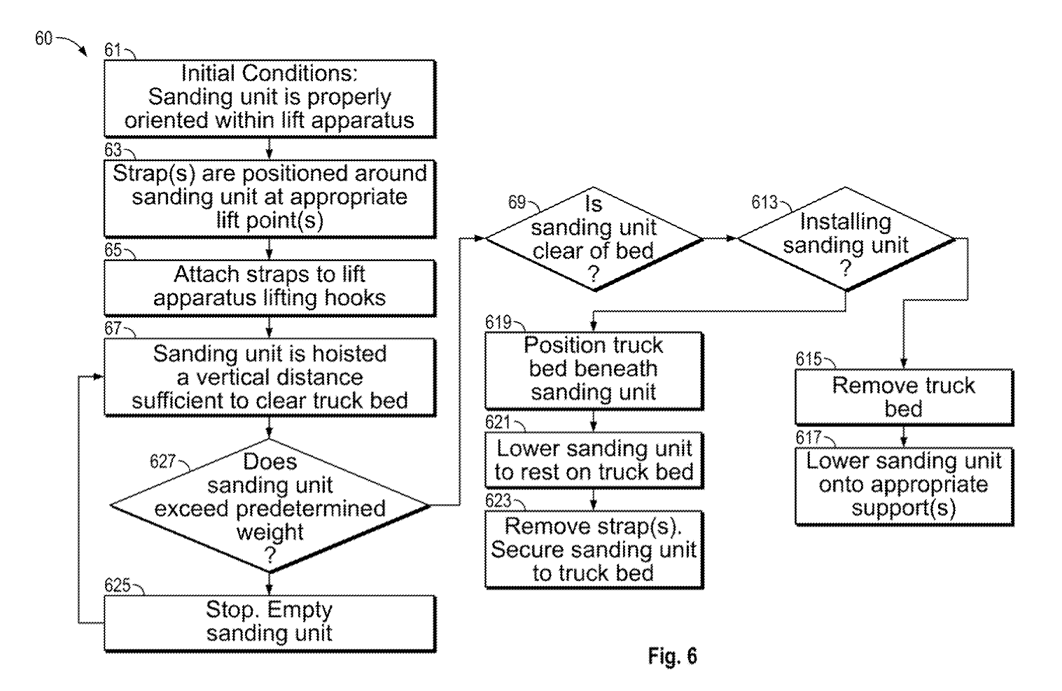

Referring, also to FIG. 6, there is shown one method 60 for removable installing a sanding hopper on a truck bed. Initial conditions 61 require that the sanding hopper is properly orientated within the apparatus 50. Straps, such as shown earlier, are positioned around hopper unit and affixed 65 to lifting hooks 55, 57. The sanding unit, or hopper, is hoisted via winch 51 a sufficient distance to clear truck bed 67. If the hopper exceeds a predetermined weight 627, the winch assembly will stop 625. The hopper must be emptied before continuing otherwise damage is likely to occur to the hopper. Once the sanding unit, is clear of the truck bed 69 the unit may then be lowered 621 onto the truck bed if installing the unit. Otherwise, the truck bed may be removed 615 if removing the unit from the truck bed. Once the truck bed is removed the unit may be lowered onto appropriate supports.

Although an exemplary embodiment of the present invention has been shown and described with reference to particular embodiments and applications thereof, it will be apparent to those having ordinary skill in the art that a number of changes, modifications, or alterations to the invention as described herein may be made, none of which depart from the spirit or scope of the present invention. For example, the structure may be any suitable material such as wood, metal, or plastic. All such changes, modifications, and alterations should therefore be seen as being within the scope of the present invention.

Additionally, the section headings used herein are provided for consistency with the suggestions under 37 CFR. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according, to the limitations of the multiple claims issuing from this disclosure, and such claims accordingly define the invention's), and their equivalents, that are protected thereby. In all instances, the scope of the claims shall be considered on their own merits in light of this disclosure, but should not be constrained by the headings set forth herein.

Use of broader terms such as comprises, includes, and having should be understood to provide support for narrower terms such as consisting of, consisting essentially of, and comprised substantially of. Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

What is claimed is:

1. A lifting and mounting apparatus for removably installing salt/sand spreader onto a truck bed, the apparatus comprising:
a plurality of pulleys;
at least one winch assembly connectable to the plurality of pulleys via a corresponding plurality of cables; and
at least one adjustable structure for mounting the plurality of pulleys and the at least one winch assembly, wherein the at: least one adjustable structure is adapted to lift and removably mount the salt/sand spreader.

2. The apparatus as in claim 1, wherein the adjustable structure comprises four vertical supports.

3. The apparatus as in claim 1, wherein the four vertical supports each comprise stabilizing foots.

4. The apparatus as in claim 2, wherein the four vertical supports each comprise ten foot steel I-beams.

5. The apparatus as in claim 2, wherein the adjustable structure comprises two outer cross beams connectable to the vertical supports.

6. The apparatus as in claim 5 wherein, the two outer cross beams each comprise ten foot steel I-beams.

7. The apparatus as in claim 2, wherein the adjustable structure comprises two upper side beams connectable to the vertical supports.

8. The apparatus as in claim 7 wherein the two upper side beams comprise 8 toot steel I-beams.

9. The apparatus as in claim 7 wherein the at least one adjustable structure comprises two inner cross beams connectible to the two upper side beams, wherein the two inner cross beams each comprise a ten foot steel I beam.

10. The apparatus as claim 1 wherein the at least one winch assembly comprises an overweight alert apparatus for alerting if the salt/sand spreader exceeds a predetermined weight.

11. A method for removably lifting and mounting a salt/sand spreader hopper (hopper) on a pickup truck's truck-bed payload area, the method comprising:
providing a hopper lifting and mounting apparatus, wherein providing the hopper lifting and mounting apparatus comprises:
providing a structure frame of sufficient depth, width, and height to accommodate the pickup truck having a truck bed;
providing a hoisting system for attaching to the hopper, wherein the hoisting system comprises:
at least one winch;
at least one hook;
a plurality of pulleys and cables attachable to the at least one winch for transferring lifting power from the at least one winch to the at least one hook by redirecting the at least one cable;
positioning the hopper within the lifting and mounting apparatus;
attaching at east one strap to the at least one hook and the hopper; and
using the at least one winch to hoist the hopper a sufficient distance to clear the truck bed payload area.

12. The method as in claim 11 wherein using the at least one winch to hoist the hopper a sufficient distance to clear the truck bed further comprises determining if the hoisted hopper exceeds a predetermined weight sufficient to damage the hopper.

13. The method as in claim 11 wherein using the at least one winch to hoist the hopper a sufficient distance to clear the truck bed further comprises determining if the hoisted hopper exceeds a predetermined weight sufficient to exceeds a gross vehicle rating of the pickup truck.

14. A lifting and mounting apparatus for removably installing salt/sand spreader onto a pickup truck's truck bed payload area, the apparatus comprising:
a plurality of pulleys;
at least one winch assembly connectable to the plurality of pulleys via a corresponding plurality of cables; and
at least one adjustable structure for mounting the plurality of pulleys and the at least one winch assembly, wherein the at least one adjustable structure is adapted to lift and removably mount the salt/sand spreader, wherein the adjustable structure comprises:
four vertical supports, each comprising:
stabilizing foots,
ten foot steel I-beams,
two ten foot outer cross steel I-beams connectable to the vertical supports,
two upper side beams connectable to the vertical supports, wherein the
two upper side beams comprise 8 foot steel I-beams.
two inner cross beams connectible to the two upper side beams, wherein
the two inner cross beams each comprise a ten foot steel I beam; and
an overweight alert apparatus for alerting if the salt/sand spreader exceeds at least one predetermined weight, wherein the at least one predetermined weight comprises a gross vehicle rating of the pickup truck.
